(19) United States
(12) Patent Application Publication
(10) Pub. No.: US 2003/0155515 A1
(43) Pub. Date: Aug. 21, 2003

(54) Radiation detector with increased life span

(76) Inventors: Jean-Pierre Moy, Monta (FR); Patrick Ducol, Coste (FR); Didier Monin, Chemin de la Burletiere (FR)

Correspondence Address: Lowe Hauptman, Gilman & Berner, Suite 310, 1700 Diagonal Road, Alexandria, VA, 22314, US

(21) Appl. No.: 10/333,360

(22) PCT Filed: Jul. 20, 2001
(86) PCT No.: PCT/FR01/02384

(30) Foreign Application Priority Data
Jul. 21, 2000 (FR) 00/09634

(51) Int. Cl. G01T 1/20

(52) U.S. Cl. 250/361 R

(57) ABSTRACT

The present invention is a radiation detector comprising a scintillator (7) made from a material sensitive to wet oxidation, placed between a photosensitive sensor (1) and an entrance window (8, 9, 80) for the radiation. The entrance window (8, 9, 80) is titanium-based.

Applicable especially to X-ray detectors for radiology or nondestructive testing.

The present invention relates to radiation detectors having a photosensitive sensor combined with a radiation converter. The fields of application of this type of detector are, in particular, radiology, namely radiography, fluoroscopy, mammography, but also nondestructive testing.

Such radiation detectors are known, for example, from French patent FR 2 605 166 in which a sensor formed from photodiodes made of amorphous silicon is combined with a converter.

The operation and the structure of such a radiation detector will be briefly summarized.

The photosensitive sensor is generally made from solid state photosensitive elements arranged in a matrix.

These elements are not directly sensitive to very short wavelength radiation such as X-rays or gamma rays. It is for this reason that the photosensitive sensor is combined with the radiation converter which comprises a layer of a scintillating substance. This substance, when it is excited by such radiation, has the property of emitting radiation having a longer wavelength (of visible light or close to visible light), to which the sensor is sensitive. The emitted light illuminates the photosensitive elements of the sensor which carry out a photoelectric conversion and deliver electrical signals which can be used by suitable circuits.

To obtain good collection of the light emitted by the converter toward the sensor, the converter and the sensor are given substantially the same size and they are coupled optically by proximity.

The coupling material, air or adhesive, has a low thickness compared with the spatial resolution of the assembly in order to degrade the quality of the image delivered by the sensor as little as possible. In a first configuration, the scintillator is deposited on a support which then forms an entrance window through which the radiation to be detected has to pass before reaching the scintillator.

In another configuration, the sensor acts as a support for the scintillator, which is then in direct and intimate contact therewith. On the surface, the sensor generally has a passivation layer intended to protect the photosensitive elements especially from moisture. The scintillator is then covered with a protective sheet, impervious to moisture, which acts as an entrance window for the radiation to be detected.

The photosensitive elements are made from semiconductor materials, usually single-crystal silicon in the case of sensors of the CCD or CMOS type, or polycrystalline or amorphous silicon. A photosensitive element has at least one photodiode, one phototransistor or one photoresistor. These elements are deposited on a substrate which is generally a glass tile.

Some scintillating substances from the alkaline halide or rare-earth oxysulfide family are frequently used for their good performance.

Cesium iodide doped with sodium or with thallium, depending on whether emission at 400 nanometers or at 550 nanometers, respectively, is desired, is known for its high absorption of X-rays and for its excellent fluorescent yield. It appears in the form of fine needles that are grown on a support. These needles are substantially perpendicular to this support and they partly confine the light emitted toward the sensor. Their fineness dictates the resolution of the detector.

Lanthanum and gadolinium oxysulfides are also very widely used for the same reasons.

However, among these substances, some have the drawback of not being very stable; they partially decompose when they are exposed to moisture and their decomposition releases chemical species which migrate either toward the sensor or away from the sensor. These species are highly corrosive. Cesium iodide and lanthanum oxysulfide especially have this drawback.

With regard to cesium iodide, its decomposition gives cesium hydroxide Cs⁺ OH⁻ and free iodine I₂ which may then combine with iodide ions in order to give the I⁻₃ complex.

With regard to lanthanum oxysulfide, its decomposition gives hydrogen sulfide H₂S which is chemically very aggressive.

Moisture is extremely difficult to remove, some is always present in ambient air, adhesive contains traces thereof, either because of the ambient air, or as a byproduct of polymerization if the latter results from the condensation of two chemical species, which is often the case.

Both configurations have advantages, but also drawbacks.

Adhesive bonding makes it possible to optimize the converter and the sensor separately. The converter may receive heat treatments which risk being incompatible with the sensor. In order to deposit cesium iodide, it is evaporated by heating and it is deposited on the support as it condenses. An annealing operation is then carried out at about 300° C. to obtain an optimum fluorescent yield. When the scintillator is deposited directly on the sensor, it is necessary to reach a compromise in respect of the annealing temperature in order not to damage the sensor.

Another advantage is that the sensor and the converter are only assembled once they have been successfully tested, which makes it possible to improve the overall manufacturing yield: with direct deposition, each time the converter is defective, the sensor is discarded since the risk of recycling is not taken.

The thickness of adhesive for the assembly introduces a few losses in terms of spatial resolution and light collection. Direct deposition of the scintillator on the sensor offers the best optical coupling conditions.

In both configurations, the entrance window must comply with the following requirements, namely be as transparent as possible to the radiation to be detected, be impervious to moisture and compatible with the chemical species released during the virtually inevitable decomposition of the scintillator, absorb or reflect the light produced by the scintillator but not transmit it, and have mechanical properties compatible with the handling undergone by the detector.

When it is desired to have available a detector whose resolution is very high, it is beneficial to provide an entrance window which absorbs the light emitted rearward by the scintillator, that is to say away from the sensor with respect to the scintillator. However, some sensitivity is lost.

On the other hand, when it is desired to have available a detector whose sensitivity is high, it is beneficial to provide an entrance window which reflects the light emitted rearward by the scintillator toward the sensor. The light signal received by the sensor is thus increased for the same amount of radiation. This gain in sensitivity is obtained at the detriment of resolution since, from one X-ray photon, the directly transmitted light and the reflected light reach the sensor at different points of impact. The image obtained is a little less sharp than in the previous case.

With current radiological detectors, under the conditions of signal-to-noise ratio of general radiography, it may be overall more beneficial to reduce the reflectivity of the entrance window. This is because several hundred electrons are created by one absorbed X-ray photon, since the scintillator transforms one X-ray photon into a large number of light photons. The main thing is that each X-ray photon be detected by the sensor after transformation into an electron. If the read noise in the sensor is comparable to the signal resulting from the absorption of an X-ray photon, then reducing the reflectivity makes it possible to improve the resolution without degrading the signal-to-noise ratio and the sensitivity.

If the scintillator is deposited on the entrance window and is attached to the sensor, the window must support, without damage, the thermal stresses of the scintillator deposition and treatment and have an expansion coefficient of the same order of magnitude as that of the scintillator and as that of the sensor (more particularly its substrate). Provision can also be made for the window to have a low modulus of elasticity, which makes it possible to remove the differential stresses between, on the one hand, the window and the scintillator and, on the other hand, the window and the sensor (more particularly its substrate). Thus the risks of crazing the scintillator and of breaking the sensor substrate are removed.

Finally, its surface condition must allow growth of the finest possible needles, in as uniform a manner as possible, especially for cesium iodide. The needle fineness is a quality factor for the detector resolution.

Currently, the entrance windows are made of aluminum. The transparency of aluminum to the radiation to be detected is excellent, its optical properties are good, the sealing against moisture is perfect, and after treatment, it is possible to obtain a satisfactory surface condition for depositing the scintillator thereon. However, its thermal properties and its corrosion resistance are not satisfactory, which means that the reliability of such a detector cannot be guaranteed under the most severe environmental conditions such as wet heat. It is desirable that such radiation detectors have a life compatible with the amortization life of radiology or other apparatuses on which they are mounted, this life being about 10 years.

The present invention provides a radiation detector with an increased life, the entrance window of which does not have the drawbacks of aluminum windows. It has been found according to the invention that it would be advantageous to replace the aluminum entrance window with a titanium-based entrance window. More specifically, the radiation detector according to the invention comprises a scintillator made from a material sensitive to wet oxidation, placed between a photosensitive sensor and an entrance window for the radiation, the entrance window being titanium based.

Such a window fulfils the requirements listed above and its cost is bearable.

The entrance window may be completely made from pure or alloyed titanium or else have a layer made of pure or alloyed titanium fastened to a dielectric layer absorbing as little as possible of the radiation to be detected.

The dielectric layer may be chosen from organic plastics, glass or ceramic.

Organic plastics from the polymer category and especially polyimide are very suitable.

The pure or alloyed titanium layer is located between the dielectric layer and the scintillator.

The performance of the detector can be improved overall and a compromise between resolution and sensitivity achieved if the pure or alloyed titanium surface of the window on the scintillator side has low reflectivity. This low reflectivity may be obtained by anodic or chemical oxidation.

The entrance window may bear the scintillator which is then fastened to the photosensitive sensor. In another configuration, it is the photosensitive sensor which bears the scintillator to which the entrance window is fastened.

The scintillator may belong to the family of alkaline halides, such as cesium iodide, or of rare earth oxysulfides, such as lanthanum oxysulfide, for example.

The invention will be better understood and other features and advantages will become apparent on reading the following description with reference to the appended figures, among which:

FIG. 1 is a schematic section of an exemplary radiation detector according to the invention;

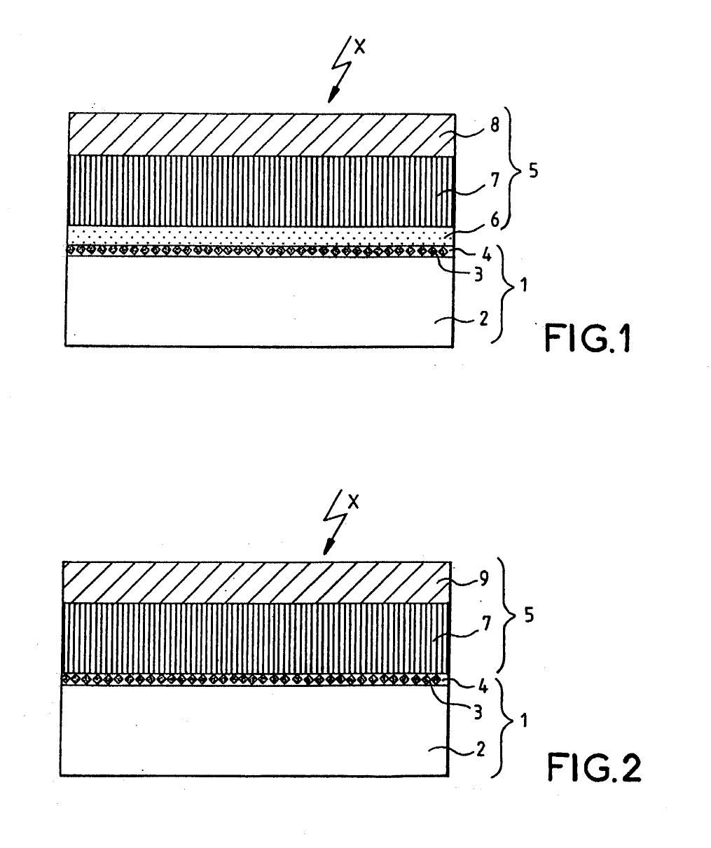

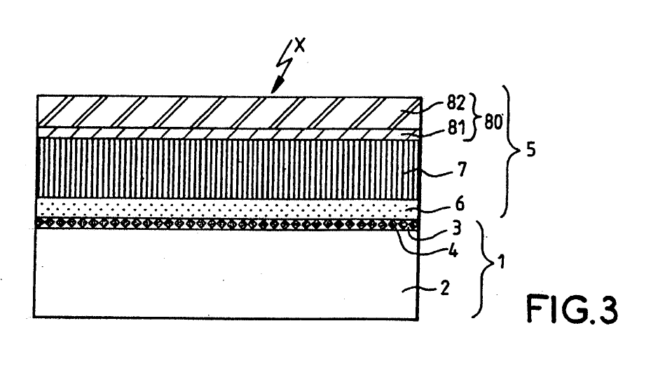

FIGS. 2 and 3 are schematic sections of variant radiation detectors according to the invention.

For the sake of clarity, these figures are not to scale.

Reference is made to FIG. 1. The radiation sensor bears the reference 1. It has a substrate 2, usually a glass tile, supporting photosensitive elements 3. Each photosensitive element 3 is mounted between a row conductor and a column conductor so that it can be addressed. The conductors are not visible in the figure for the purpose of simplification. The photosensitive elements 3 and the conductors are generally covered with a passivation layer 4 intended to protect them against moisture.

The sensor 1 cooperates with a converter 5 which, in the example, is optically coupled to the sensor 1 with optical adhesive 6. The converter 5 has a scintillator layer 7, shown with a needle-like structure, deposited on a support 8. The support 8 thus bears the scintillator 7. Instead of being made of aluminum, as before, this support 8 is titanium based. This support 8 acts as an entrance window for the X-rays. It is assumed that the scintillator 7 belongs to the family of alkaline halides such as cesium iodide which is particular sensitive to wet oxidation, but it could also belong to the rare earth oxysulfide family, some members of which are also not very stable, such as lanthanum oxysulfide.

Aluminum is not entirely satisfactory mainly because of its poor resistance to corrosion by the decomposition byproducts of the scintillator.

Everything would suggest replacing it with a precious metal in spite of its cost. However, precious metals (gold, silver, platinum, etc.) would not be satisfactory since their atomic numbers are much too high (47 for silver, 78 for platinum and 79 for gold) and they absorb the incoming radiation (X-rays, gamma rays) far too much. Absorption of such radiation by a single body increases with the cube of its atomic number. It would therefore be necessary to increase the doses and the energy of the radiation far too much in order to be able to use them.

Titanium is known to be attacked by pure iodine from 25° C. upward, as indicated in the “Traité de Chimie Minérale” [Treatise on Mineral Chemistry] by P. Pascal, published by Masson.

The inventors have noticed that titanium is good at resisting corrosion arising from the decomposition of cesium iodide in wet air, although the wet decomposition of cesium iodide produces the element iodine, but the amounts are small.

It appears that titanium also resists the byproducts originating from the decomposition of lanthanum oxysulfide.

The atomic number of titanium (22) is much higher than that of aluminum (13), which does not suggest choosing it. However, its mechanical properties and its mean density of about 4.5 make its use possible by adapting its thickness, of about 50 to 100 micrometers for example, so that the absorption of the radiation to be detected is suitable.

In fact, a support with a side length of about 50 centimeters made of pure or alloyed titanium, whose thickness is within the range mentioned above, is sufficiently rigid to be handled without any particular precaution. With such thicknesses, in general radiography, the absorption of X-rays is increased to about 2 to 5%, which is acceptable. General radiography corresponds to energies of between about 30 keV and 150 keV and to doses of between 1 and 50 micrograys.

With regard to the optical properties, on treating a titanium sheet by means of anodic or chemical oxidation, a gray or even colored tarnished and low reflectivity surface is obtained. This treatment can be carried out with hydrofluoric/nitric acid. A diffuse reflectivity typically from 30 to 40% and even from 25 to 60% can be obtained only with pure titanium instead of from 60 to 80% obtained with aluminum.

The support 8 may be made of pure or alloyed titanium, for example TA6V which is a widely-used titanium alloy.

In addition, titanium or its alloys have the required thermal and elasticity properties and the required property of impermeability to moisture and a satisfactory surface condition can be obtained for growing cesium iodide.

The merit factors of the X-ray detectors, known by the name of detected quantum efficiency (DQE) and modulation transfer function prove to be better with a titanium-based window than with an aluminum-based window.

Instead of depositing the scintillator 7 on the titanium-based support 8 and fastening the assembly to the sensor 1, as illustrated in FIG. 1, it is possible to deposit the scintillator 7 directly on the sensor 1 and to cover the scintillator 7 with a titanium-based sheet 9 which acts as an entrance window for the X-rays. This variant is illustrated in FIG. 2.

It is possible to envision, especially for reducing the absorption of the radiation to be detected, combining the pure or alloyed titanium with a dielectric absorbing this radiation as little as possible, such as an organic plastic, ceramic, or glass. Reference may be made to FIG. 3 which shows an entrance window 80 having a pure or alloyed titanium layer 81 fastened to a dielectric layer 82. The titanium layer 81 is on the same side as the scintillator and it is covered with the dielectric layer 82.

Some organic plastics (polymers) have the advantage of hardly absorbing even the low-energy X-rays, and of withstanding high temperatures, of having good mechanical and elastic properties, and of being easily shaped. Their drawback is that they do not provide the required sealing against moisture, but this requirement is obtained by the titanium.

Glasses or ceramics containing few heavy elements may also be suitable, especially from the X-ray absorption point of view.

It will be possible to deposit the pure or alloyed titanium layer 81 on the scintillator by any means known to the specialist, for example sputtering, vacuum evaporation, chemical deposition, electrolytic deposition. A pure or alloyed titanium sheet could even be fastened by adhesive bonding to the dielectric layer. The pure or alloyed titanium layer may have a thickness of a few micrometers.

The structure as described in FIG. 1 has many advantages compared with that described in FIG. 2.

The structure as described in FIG. 1 allows better management of the production stream by allowing the separate manufacture of the two elements which are, on the one hand, the scintillator 7 on its substrate 8 and, on the other hand, the sensor 1.

Moreover, the cost of the support 8 as described in FIG. 1 is less than that of the sensor 1 as described in FIG. 2. This will thus lead to less loss in the case of a deficient scintillator 7 deposit which would lead to the rejection either of the converter 5 in the case of FIG. 1 or of the sensor 1 and of the scintillator 7 in the case of FIG. 2.

Finally, the structure as described in FIG. 1 can be applied to photosensitive elements consisting of sets of several joined elements, such as for example described in the French patents published under numbers FR 2 758 654 and FR 2 758 656. The structure of FIG. 2 cannot be applied to such photosensitive assemblies consisting of assemblies of several joined elements, because of the poor dimensional stability of such assemblies at a temperature of 300° C., which temperature is needed for implementing the scintillator 7 after it is deposited on its support 8 in the case of FIG. 1 or on the sensor 1 in the case of FIG. 2. As for the support 8 as described in FIG. 1 (or the entrance window 80 of FIG. 3), it is compatible with such a temperature.

1. A radiation detector comprising a scintillator (7) made from a material sensitive to wet oxidation, placed between a photosensitive sensor (1) and an entrance window (8, 80) for the radiation, characterized in that the entrance window (8, 80) is titanium based and in that the entrance window (8, 80) bears the scintillator (7).

2. The radiation detector as claimed in claim 1, characterized in that the entrance window (8) is made from pure or alloyed titanium.

3. The radiation detector as claimed in claim 1, characterized in that the entrance window (80) is made from a pure or alloyed titanium layer (81) fastened to a dielectric layer (82) absorbing as little as possible of the radiation to be detected.

4. The radiation detector as claimed in claim 3, characterized in that the dielectric layer (82) is made from an organic plastic, glass or ceramic.

5. The radiation detector as claimed in claim 4, characterized in that the organic plastic is from the category of polymers such as polyimide.

6. The radiation detector as claimed in one of claims 3 to 5, characterized in that the pure or alloyed titanium layer (81) is located between the dielectric layer (82) and the scintillator (7).

7. The radiation detector as claimed in one of claims 1 to 6, characterized in that the entrance window (8, 80) has a thickness of between about 50 to 100 micrometers.

8. The radiation detector as claimed in one of claims 1 to 7, characterized in that the entrance window (8, 80) has, on the same side as the scintillator (7), a surface with low reflectivity.

9. The radiation detector as claimed in claim 8, characterized in that the low-reflectivity surface is obtained by oxidation.

10. The radiation detector as claimed in either of claims 8 and 9, characterized in that the low-reflectivity surface has a reflectivity of between 25 and 60%.

11. The radiation detector as claimed in one of claims 1 to 10, characterized in that the entrance window (8, 80) and the scintillator (7) are fastened to the photosensitive sensor (1).

12. The radiation detector as claimed in one of claims 1 to 11, characterized in that the scintillator belongs to the family of alkaline halides such as cesium iodide or of rare earth oxysulfides such as lanthanum oxysulfide.

13. The radiation detector as claimed in one of claims 3 to 12, characterized in that the pure or alloyed titanium layer is adhesively bonded to the dielectric layer.

14. The radiation detector as claimed in one of claims 3 to 12, characterized in that the pure or alloyed titanium layer is deposited by sputtering, evaporation, chemical deposition, electrolytic deposition on the dielectric layer.
